(19) United States
(12) Patent Application Publication
(10) Pub. No.: US 2025/0036095 A1
(43) Pub. Date: Jan. 30, 2025

(54) PARALLEL ARCHITECTURE FOR COMBINATORIAL OPTIMIZATION

(71) Applicant: The Regents of the University of California, Oakland, CA (US)

(72) Inventors: Sayeef Salahuddin, Walnut Creek, CA (US); Saavan Kanu Patel, Oakland, CA (US)

(21) Appl. No.: 18/226,580

(22) Filed: Jul. 26, 2023

(51) Int. Cl. G05B 19/042

(52) U.S. Cl. CPC G05B 19/0421

(57) ABSTRACT

A parallel architecture for combinatorial optimization can be implemented on a parallel processor, such as a field programmable gate array (FPGA), that includes a memory management system coupled to a memory of the parallel processor, wherein the memory stores a weight matrix; a sampling engine on the parallel processor, the sampling engine coupled to receive weights of the weight matrix stored in the memory from the memory management system and perform as a restricted Boltzmann machine for a set of inputs using the received weights, wherein the sampling engine comprises a dual architecture of a first circuit for updating visible states and a second circuit for updating hidden states; and a probability estimator that receives updated visible states and updated hidden states from the sampling engine.

### GOVERNMENT SUPPORT

This invention was made with government support under Grant No. HR0011-18-3-0004 awarded by the Department of Defense/Defense Advanced Research Projects Agency (DARPA). The government has certain rights in the invention.

### BACKGROUND

Combinatorial Optimization problems are a particularly important class of computing problem and are prevalent across disciplines, from scheduling and logistics to analysis of physical systems to efficient routing. These problems belong to the NP-Hard and NP-Complete class, where no polynomial time solution exists. This leads to an interest in novel algorithms, architectures, and systems to solve these problems. The Ising Model problem is an example of this type of problem, with foundations in statistical physics. For this reason, the Ising Model has emerged as an efficient way of mapping these problems onto various physical accelerators.

The Boltzmann Machine is a stochastic neural network over binary variables which maps directly onto the Ising model. Because of this, the Boltzmann Machine has received attention for its usage to solve Combinatorial Optimization problems. However, the standard Gibbs Sampling algorithm used with the Boltzmann Machine is computationally expensive due to its sequential nature, and many samples needed to reach convergence. Restricted Boltzmann Machine (RBM) can address some of these problems by introducing a parallel sampling scheme via removing intra-layer connections. Therefore, Restricted Boltzmann Machines have found substantial interest as next generation accelerators for computationally difficult problems.

### BRIEF SUMMARY

A parallel architecture for combinatorial optimization is provided. In certain implementations, a parallel stochastic sampling scheme of a restricted Boltzmann machine is mapped onto a parallel processor such as provided by a field programmable gate array (FPGA) or an Application Specific Integrated Circuit (ASIC). Through the described multiplier-free design, a single parallel processor's resources of memory and compute can be used to accelerate combinatorial optimization problems.

A combinatorial optimization accelerator having a parallel architecture for combinatorial optimization includes a memory management system on a parallel processor coupled to a memory of the parallel processor, wherein the memory stores a weight matrix: a sampling engine on the parallel processor, the sampling engine coupled to receive weights of the weight matrix stored in the memory from the memory management system and perform as a restricted Boltzmann machine for a set of inputs using the received weights, wherein the sampling engine includes a dual architecture of a first circuit for updating visible states and a second circuit for updating hidden states; and a probability estimator that receives updated visible states and updated hidden states from the sampling engine.

In a further implementation, the combinatorial optimization accelerator can incorporate parallel tempering. A combinatorial optimization accelerator using parallel tempering includes a plurality of the sampling engines, a corresponding plurality of the probability estimators, and a swap controller. The sampling engines can receive weights of the weight matrix and an inverse temperature parameter. The swap controller calculates swap probabilities and performs swaps between two units, each formed of a sampling engine and corresponding probability estimator, once samples have been updated for that unit. A memory management system can stream copies of the weight matrix to multiple copies of the sampling engines.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative diagram of a parallel processor system implementing a parallel architecture for combinatorial optimization.

FIGS. 2A and 2B show two weight streaming architectures.

FIG. 3 is a representation of a reconfigurable stochastic sampling engine.

FIG. 4 demonstrates weight streaming through time for a non-symmetric matrix implementation.

FIG. 5 illustrates an architecture supporting the streaming of weights diagonals.

FIG. 6 shows an illustrative diagram of a parallel processor system implementing a parallel architecture for combinatorial optimization using parallel tempering.

FIG. 7 shows an illustrative architecture incorporating parallel tempering.

### DETAILED DESCRIPTION

A parallel architecture for combinatorial optimization is provided. The described combinatorial optimization accelerator implementing a parallel architecture can be used in numerous applications. For example, the described accelerator can be used for circuit place and route algorithms that can be part of or used by electronic design automation tools. The maxcut problem and the Ising model may be used in generating automatic place and route results for design layouts of circuits and can assist in cases of 3D integration. As another example, the Ising model and described accelerator can be used for supply chain logistics/last mile delivery such as efficient routing of a fleet of delivery vehicles to pickup packages and to rapidly re-route packages and drivers.

In certain implementations, a parallel stochastic sampling scheme of a restricted Boltzmann machine is mapped onto a parallel processor such as provided by a field programmable gate array (FPGA) or an Application Specific Integrated Circuit (ASIC). Through the described multiplier-free design, a single parallel processor's resources of memory and compute can be used to accelerate combinatorial optimization problems.

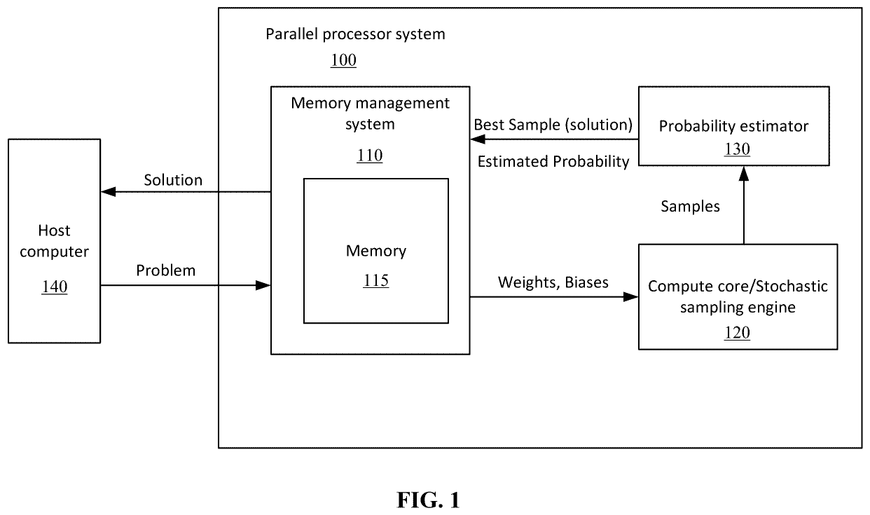

FIG. 1 shows an illustrative diagram of a parallel processor system implementing a parallel architecture for combinatorial optimization. Referring to FIG. 1, the parallel architecture of the parallel processor system 100 includes a memory management system 110, a stochastic sampling engine 120, and a probability estimator 130.

The memory management system 110 is coupled to the memory 115 and configures how the memory 115 of the parallel processor system 100 is used. The memory 115 of the parallel processor system 100 can include dynamic random access memory (DRAM), static random access memory (SRAM), or a stacked random access memory (e.g., stacked synchronous dynamic random-access memory (SDRAM), high bandwidth memory (HBM)), and the like.

The chip (e.g., device of the parallel processor system 100) has a certain amount of memory 115 available (e.g., RAM). The memory 115 is used to store a weight matrix. The weight matrix may be symmetric or asymmetric. The memory management system 110 supports the reading and writing to the memory 115, for example, the writing and reading of rows and columns of the matrix. In such a case, the memory management system 110 can read out a row of weights and feed as many rows to the stochastic sampling engine 120 as possible in one clock cycle (which depends on particular implementation).

The memory management system 110 can be used to store the weight matrix used by the stochastic sampling engine 120 in a manner that maintains row and column awareness. That is, the memory management system 110 can track the row and column of a weight when streaming weights of the matrix to the stochastic sampling engine 120. This allows for streaming of rows, columns, diagonals, and/or sub-matrices.

The stochastic sampling engine 120 is coupled to receive weights of the weight matrix and may perform as a restricted Boltzmann machine (RBM) for a set of inputs with the assistance of the memory management system 110.

An RBM is an algorithm for a generative stochastic neural network, formed of two layers, that can be used to learn or describe a probability distribution over a set of inputs. The first layer of the RBM is the visible layer (e.g., the input layer, ν) and the second layer of the RBM is the hidden layer, h. The RBM encodes an exponential family probability distribution over binary variables p(ν, h), which can be represented as follows.

$$p ( v , h ) = \frac{1}{Z} {e}^{- E ( v , h )} , v ∈ {\{ 0 , 1 \}}^{n} , h ∈ {\{ 0 , 1 \}}^{m} ,$$

where the energy function E(ν, h) reflects the problem being solved and is simplified to reflect linear synaptic weights with two body interactions.

For example, a bipartite graph for the RBM can be formed from a fully connected Ising model problem and the RBM energy function set to E(υ,h)=υ^{T}Wh where W is the bipartite graph's weight matrix. The weight matrix encodes the lowest energy states in the original Ising Model problem as the highest probability state in the RBM probability distribution.

The stochastic sampling engine 120, as part of the compute core, performs parallelized updates of the visible/hidden states using a Gibbs Sampling update. That is, Gibbs sampling can be performed on the RBM probability distribution to generate samples of the RBM probability distribution. Gibbs sampling is a type of Markov Chain Monte Carlo.

In detail, each neuron has a stochastic activation function where p(νᵢ=1|h)=σ(wᵢ^{T}h+bᵢ) and σ(x)=(1+e^{-x})⁻¹, with wᵢ being the ith row vector of the weight matrix, and bᵢ being the bias associated with that neuron. The lack of intra-layer connections allows for each neuron in a layer to be sampled in parallel, creating a massively parallel sampling scheme. Each layer is sampled and the result is passed to the next layer to get the next sample.

As mentioned above, this RBM algorithm and Gibbs sampling can be accelerated through implementation on the described parallel processor system 100. The circuitry of the stochastic sampling engine 120 for the visible updates is able to implement \vec{ν}=σ(W\vec{h}+\vec{b_{ν}}). νᵢ=σ(Σⱼwᵢⱼhⱼ+bᵢ) and the circuitry for the hidden updates is able to implement \vec{h}=σ(W^{T}\vec{ν}+\vec{bₕ}), hⱼ=σ(Σᵢwᵢⱼνᵢ+bⱼ).

In operation, the memory management system 110 of the parallel processor interfaces with a host system 140 to receive the problem to be solved. The memory management system 110 streams rows (or columns or diagonals) of the weights matrix (such as the weight matrix that may be generated when transforming a fully connected Ising model problem to the bipartite graph structure in the RBM) to the sampling engine 120 utilizing as many memory blocks as is available in the memory 115 on the parallel processor system 100.

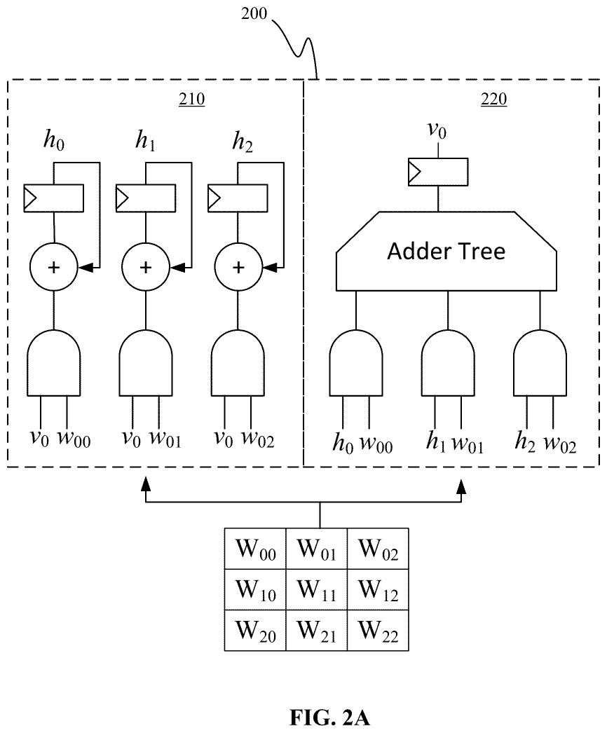

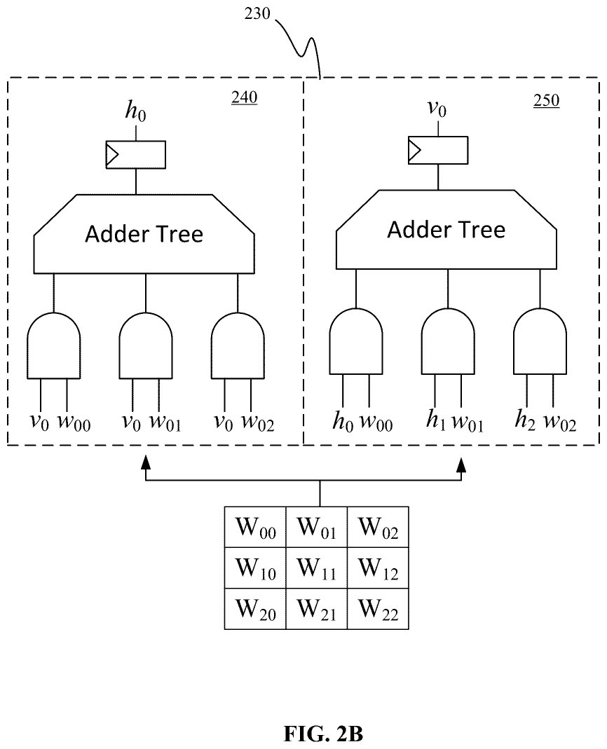

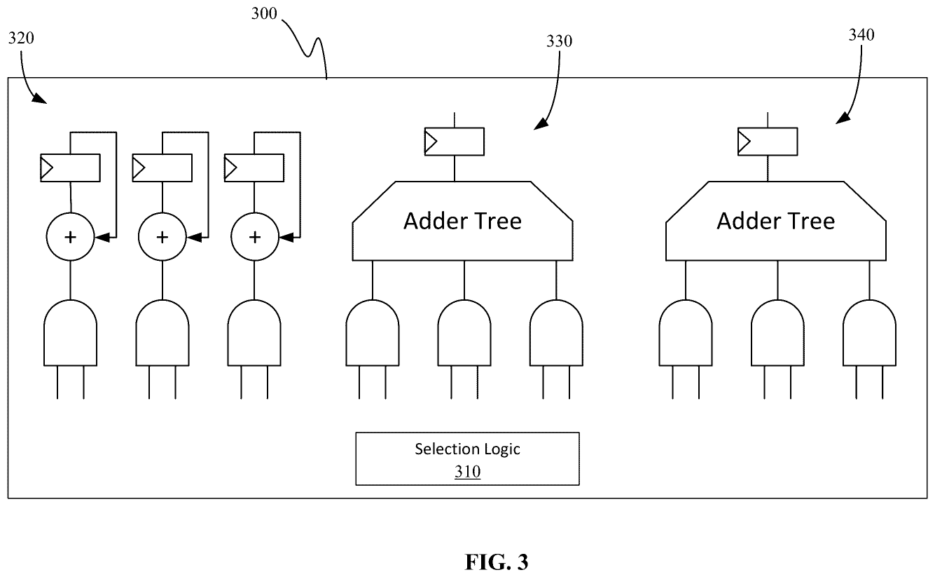

The stochastic sampling engine 120 performs parallelized updates of the visible/hidden states using the Gibbs Sampling update (e.g., as implemented by the circuitry described in FIGS. 2A and 2B). In some cases, the circuitry of the stochastic sampling engine 120 can be reconfigurable and set based on the weight matrix and method of streaming. An example representation of reconfigurable circuitry of the stochastic sampling engine 120 is shown in FIG. 3. The probability estimator 130 takes the visible/hidden states (the samples) being updated and keeps track of the best state seen so far and streams this back to the host system 140 to indicate problem completion. That is, the probability estimator 130 is given a set of samples from the stochastic sampling engine 120 and determines the result, for example, by identifying a sample that satisfies certain criteria, or in a more general case, the sample representing the highest probability seen so far.

FIGS. 2A and 2B show two weight streaming architectures. FIG. 2A shows a scheme for non-symmetric matrices and FIG. 2B shows a scheme for symmetric matrices. As illustrated in FIG. 3, the two alternate architectures can be available, depending on whether the weight matrix is symmetric or not. It should be understood that a 3×3 matrix for weights (and corresponding 3 two-input AND gates and circuitry) are shown for illustrative purposes only and the size of the matrix and corresponding circuits are based on particular applications and constraints of the hardware. It should be understood that the AND gate implementations are just one example providing the binary multiplication and other gates may be used, for example, a digital multiplexer (MUX) or equivalent alternative.

The sampling engine 120 performs stochastic sampling based on the weight matrix. The weight matrix forms a probability distribution through stochastic sampling, for example according to the restricted Boltzmann machine probability distribution. The sampling engine 120 performs a matrix vector multiplication, but since the visible updates and the hidden updates are binary values, it is possible to use an AND gate or a digital MUX (or other gate). For non-symmetric matrices, for visible updates, the sampling engine adds up all elements of a row. For hidden updates, the sampling engine adds up all elements of a column. Thus, as the row-by-row accumulation occurs, the hidden updates are accumulating each element of a row and the visible updates are accumulating over each row itself (e.g., adding up each element of a row), such that the column is multiplexed through time.

Referring to FIGS. 2A and 2B, to avoid storing both the matrix and its transpose, a dual architecture is used for hidden updates and visible updates, allowing for simultaneous update of both visible and hidden nodes while maintaining the same weight streaming architecture. Additionally, since the hidden values and the visible values are binary, these binary activations allow for multiplier-free system for Restricted Boltzmann Machine (RBM) implementations, yielding further hardware efficiency. Indeed, the matrix vector multiplication can be carried out by sending the elements to AND gates, representing a large decrease in hardware usage.

As shown in FIG. 2A, in the dual architecture of a stochastic sampling engine 200 for a case where the weight matrix is non-symmetric, visible state updates are accumulated through a first circuit 210 and hidden state updates are accumulated through a second circuit 220 that is different than the first circuit 210. The first circuit 210 combines elements over time for each row, where visible inputs and the weights of a row are input as the two inputs to corresponding AND gates and the output of each AND gate is accumulated. The second circuit 220 combines elements of a column. This is accomplished using an Adder Tree instead of individual accumulators for the outputs of the AND gates.

As shown in FIG. 2B, in the dual architecture of a stochastic sampling engine 230 for a case where the weight matrix is symmetric, visible updates are accumulated through a first circuit 240 and hidden updates are accumulated through a second circuit 250 that has the same configuration as the first circuit 240. Here, both the first circuit 240 and the second circuit 250 are in the form of AND gates and an Adder Tree.

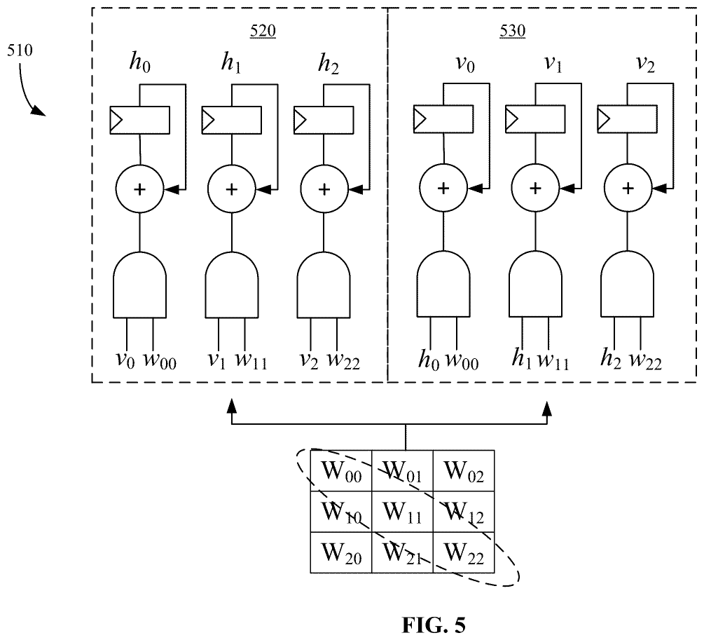

In some cases, described in more detail with respect to FIG. 5, the first circuit and the second circuit can both be configured with the individual accumulators such as first circuit 210 of FIG. 2A.

FIG. 3 is a representation of a reconfigurable stochastic sampling engine. Referring to FIG. 3, a stochastic sampling engine 300 includes circuitry that can support both symmetric matrices and non-symmetric matrices and selection logic 310 that can set which grouping of circuitry is used for a particular application. In the example stochastic sampling engine 300, three circuit blocks are shown, a first circuit block 320, a second circuit block 330, and a third circuit block 340. For non-symmetric matrices, the first circuit block 320 can be selected by the selection logic 310 as the circuit for visible updates and the second circuit block 330 (or the third circuit block 340) can be selected by the selection logic 310 as the circuit for hidden updates. In some cases, a fourth circuit block (not shown) may be included for use in the configuration shown in FIG. 5. The selection logic 310 enables the same stochastic sampling engine 300 to be used for different applications (and corresponding weights) without restriction regarding whether the matrix is symmetric or non-symmetric since the desired architecture can be obtained. Of course, it should be noted that a non-reconfigurable stochastic sampling engine can be used. For example, if the application or weight matrix structure is known before hand, it is possible to have a fixed hardware that only does symmetric-type updates or asymmetric-type updates, which allows for a smaller footprint than the hardware that includes hardware supporting multiple types of updates.

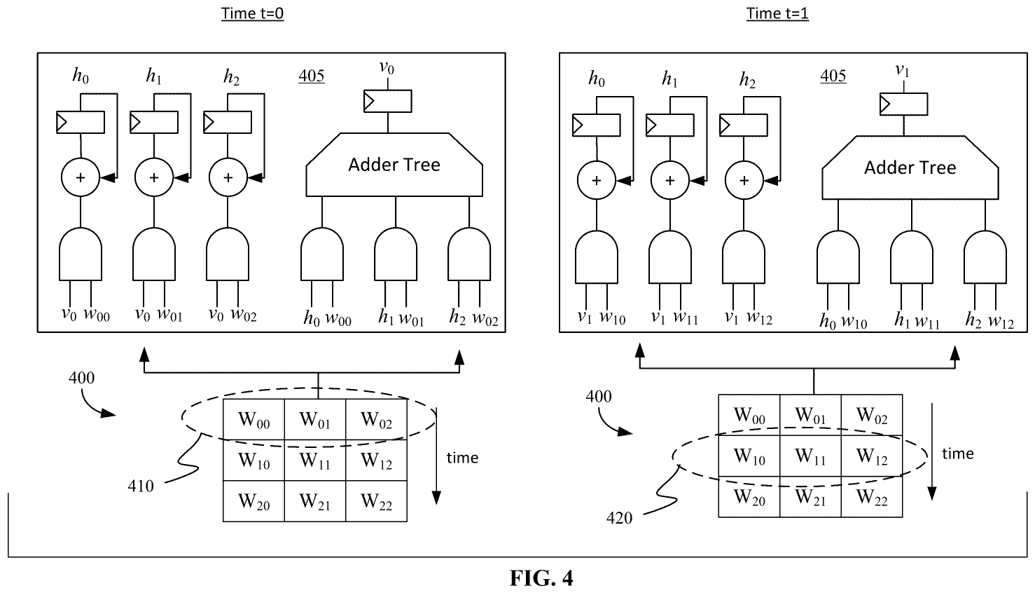

FIG. 4 demonstrates weight streaming through time for a non-symmetric matrix implementation. Referring to FIG. 4, a memory management system 400 feeds as many rows of the weight matrix to the stochastic sampling engine 405 during a single clock cycle. Here, at t=0, the first row 410 of the weight matrix is sent to the stochastic sampling engine 405 for combining with the input elements. As time progresses, an additional row (e.g., second row 420) is streamed to the compute-core for computation. This is reflected by the update at t=1 showing a second row is sent to the stochastic sampling engine to combine with the next visible element (vi) while the hidden elements being added continue to update. The hidden values are obtained after the rows are all read in (in order to complete a column). As can be seen, it is possible to carry out ν₁=σ(Σⱼwᵢⱼhⱼ+bᵢ) and hⱼ=σ(Σᵢwᵢⱼνᵢ+bⱼ).

For each unit of time as time progresses, a new entry (row, column or diagonal) of the weights matrix can be streamed out from the accelerator memory, and used to update the neuron states. Depending on the specific hardware architecture used (ASIC vs. FPGA), different architectures can stream either the columns, rows, or diagonals.

FIG. 5 illustrates an architecture supporting the streaming of weights diagonals. Referring to FIG. 5, the dual architecture of the stochastic sampling engine 510 can include the AND gate with corresponding accumulator circuitry for both the visible element circuit 520 and hidden element circuit 530 such that both hidden and visible updates use the accumulator architecture.

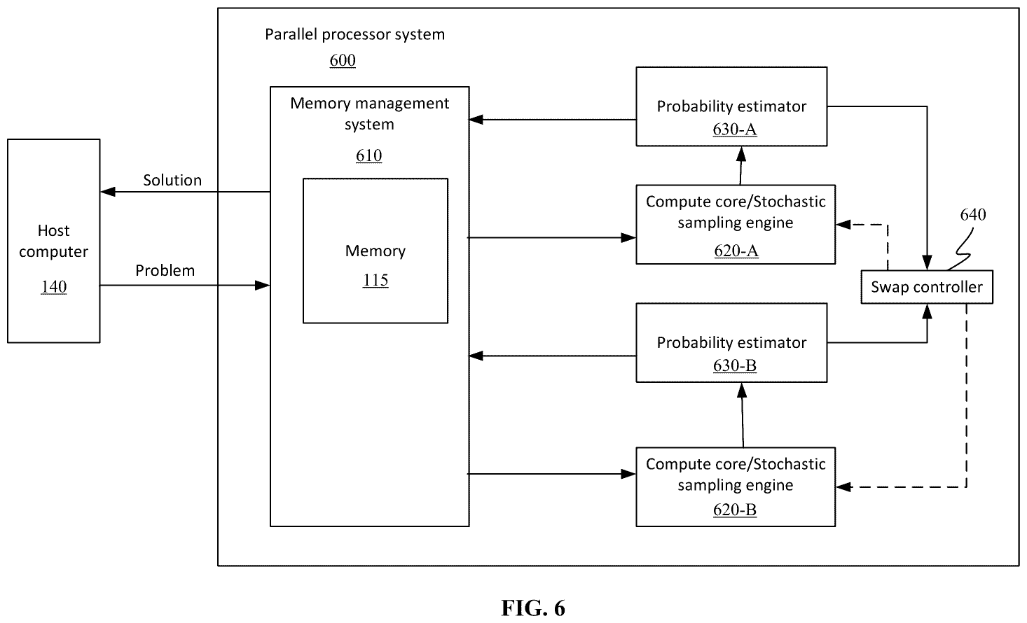

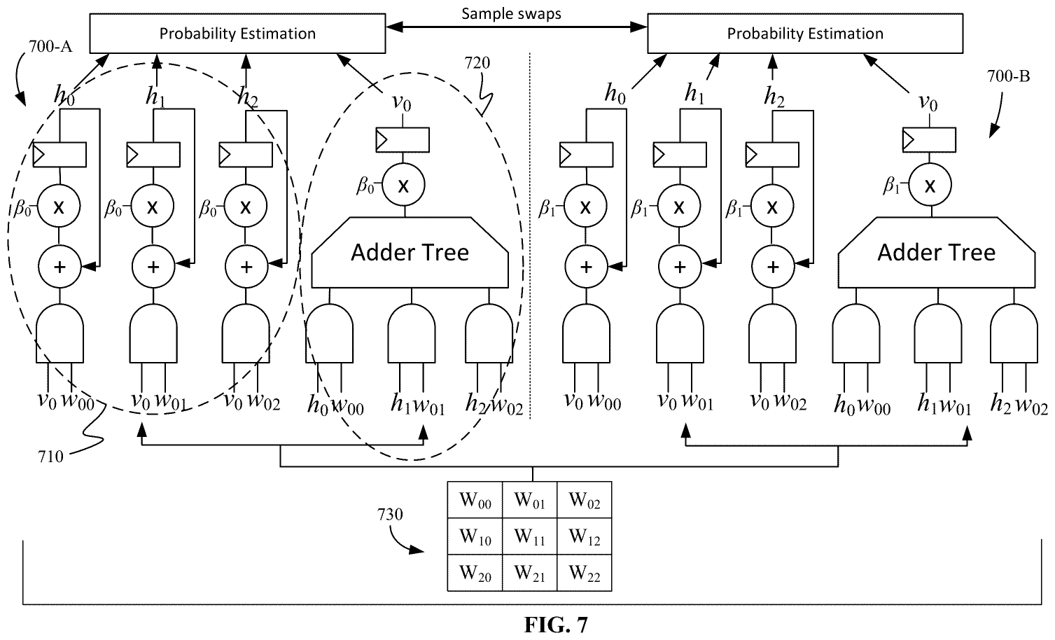

FIG. 6 shows an illustrative diagram of a parallel processor system implementing a parallel architecture for combinatorial optimization using parallel tempering; and FIG. 7 shows an illustrative architecture incorporating parallel tempering. Parallel tempering may be used in the case that the underlying hardware platform (ASIC, FPGA, or otherwise) has additional space to support more parallel copies.

Performance of the described parallel architecture can be further improved by including parallel tempering. Parallel tempering is a method that has been shown to accelerate convergence of sampling from a RBM distribution. The hardware accelerator for stochastic sampling (and combinatorial optimization) can be extended to support parallel tempering by adding an inverse temperature parameter (p), and by allowing for swaps between many copies of the system.

Referring to FIG. 6, the parallel architecture for combinatorial optimization using parallel tempering of the parallel processor system 600 includes a memory management system 610, plurality of stochastic sampling engines (e.g., first stochastic sampling engine 620-A, second stochastic sampling engine 620-B), corresponding plurality of probability estimators (e.g., first probability estimator 630-A, second probability estimator 630-B), and a swap controller 640.

Similar to that described with respect to FIG. 1, memory management system 610 configures how the memory 115 of the parallel processor system 600 is used. The memory 115 of the parallel processor system 600 can include dynamic random access memory (DRAM), static random access memory (SRAM), or a stacked random access memory (e.g., stacked synchronous dynamic random-access memory (SDRAM), high bandwidth memory (HBM)), and the like.

The chip (e.g., device of the parallel processor system 600) has a certain amount of memory 115 available (e.g., RAM). The memory 115 is used to store a weight matrix, as well as other information used by the system 600. The weight matrix may be symmetric or asymmetric. The memory management system 610 supports the reading and writing to the memory 115 and provides the weights (and other information such as the inverse temperature parameter β) to each of the plurality of stochastic sampling engines (first stochastic sampling engine 620-A, second stochastic sampling engine 620-B in the illustrative example). Memory management system 610 can stream rows, columns, diagonals, and/or sub-matrices of the weight matrix to the stochastic sampling engines.

In operation, the memory management system 610 of the parallel processor interfaces with a host system 140 to receive the problem to be solved. The memory management system 610 streams rows (or columns or diagonals) of the weights matrix (such as the weight matrix that may be generated when transforming a fully connected Ising model problem to the bipartite graph structure in the RBM) to each of the plurality of sampling engines. Each stochastic sampling engine (e.g., first stochastic sampling engine 620-A, second stochastic sampling engine 620-B in the illustrative example) performs parallelized updates of the visible/hidden states using the Gibbs Sampling update, for example, as described in more detail with respect to FIG. 7. The corresponding probability estimator (e.g., first probability estimator 630-A, second probability estimator 630-B) for each stochastic sampling engine takes the visible/hidden states (the samples) being updated and keeps track of estimated probabilities. The swap controller 640 calculates the probabilities of each of the visible state copies output by the corresponding probability estimators (e.g., first probability estimator 630-A, second probability estimator 630-B) and decides whether to swap the probabilities based on a swap rule. The results of the sampling and probability estimation can be streamed back to the host system 140 to indicate problem completion. That is, a combinatorial optimization accelerator using parallel tempering can include a plurality of the sampling engines, a corresponding plurality of the probability estimators, and a swap controller. The sampling engines can receive weights of the weight matrix and an inverse temperature parameter. The swap controller calculates swap probabilities and performs swaps between two units, each formed of a sampling engine and corresponding probability estimator, once samples have been updated for that unit. The memory management system can stream copies of the weight matrix to multiple copies of the sampling engines.

Referring to FIG. 7, a nonsymmetrical weight matrix implementation of two stochastic sampling engines 700-A, 700-B (e.g., first stochastic sampling engine 620-A and second stochastic sampling engine 620-B, respectively) can each include a first circuit 710 and a second circuit 720 that includes a β parameter multiplier for each update. Sample swaps can be carried out between the corresponding probability estimation from the outputs of the stochastic sampling engines. It should be understood that while two copies of the stochastic sampling engines (and probability estimators) are shown in FIG. 6 and FIG. 7, more than two may be implemented. Indeed, many inverse temperature copies are possible and usable for solving of complex problems. In addition, as can be seen, the streamed weights (e.g., of weight matrix 730) can be reused for many copies of the stochastic sampling engine accelerator to further increase data efficiency.

In operation, each of the temperature parameters (β) can be set before the problem begins, and depend on the weights and problem of interest. The individual neuron updates are then modified for both the visible updates and the hidden updates to be multiplied by the temperature parameter for that RBM copy (see e.g., β parameter multiplier in the first circuit 710 and the second circuit 720 of the first stochastic sampling engine 700-A and in the second stochastic sampling engine 700-B).

For the visible updates this becomes: \vec{ν}=σ(βₖ(W\vec{h}+\vec{b_{ν}})), νᵢ=σ(βₖ(Σⱼwᵢⱼhⱼ+bᵢ)), while the hidden updates similarly include the same beta parameter and is given as \vec{h}=σ(βₖ(W^{T}^{_{\vec{ν}}}+\vec{bₕ})), hⱼ=σ(βₖΣᵢwᵢⱼνᵢ+bⱼ). After each neuron update, a sample swap controller (e.g., swap controller 640) calculates the probabilities of each of the visible state copies, and decides whether to swap the probabilities based on a swap rule given by

$$P ( swap ) = max ( 1 , \frac{{P}_{2} ( {v}_{1} ) {P}_{1} ( {v}_{2} )}{{P}_{1} ( {v}_{1} ) {P}_{2} ( {v}_{2} )} ) ,$$

where P₁(x) and P₂(x) are the probabilities given by the first model (e.g., first probability estimator 630-A) and second model (e.g., second probability estimator 630-B) respectively, while ν₁ and ν₂ are the vector outputs (e.g., visible updates) from the first and second model for that sampling step.

Accordingly, a method for combinatorial optimization using parallel tempering of the parallel processor system can include receiving, at the combinatorial optimization accelerator, a problem to be solved from a host system; streaming, by the memory management system, the weights to the sampling engine; receiving, by the sampling engine, a set of inputs and the weights from the memory management system to perform parallel updates of the visible states and the hidden states; receiving, by the probability estimator, the updated visible states and the updated hidden states from the sampling engine to identify states that satisfy certain criteria; and outputting, by the probability estimator, the identified states. The method further includes streaming, by the memory management system, the weights to the second sampling engine; receiving, by the second sampling engine, the set of inputs and the weights from the memory management system to perform parallel updates of corresponding visible states and corresponding hidden states; receiving, by the second probability estimator, the updated corresponding visible states and the updated corresponding hidden states from the second sampling engine to identify states that satisfy certain criteria; receiving, at the swap controller, estimated probabilities from the probability estimator and the second probability estimator; and performing, by the swap controller, swaps of samples for visible states and hidden states between the sampling engine and the second sampling engine based on the estimated probabilities from the probability estimator and the second probability estimator.

The sampling engine and the second sampling engine can each further receive corresponding temperature parameters; and multiply the corresponding temperature parameters with visible updates and hidden updates at that sampling engine.

In some cases, performing, by the swap controller, swaps of samples for visible states and hidden states between the sampling engine and the second sampling engine based on the estimated probabilities from the probability estimator and the second probability estimator comprises: calculating a swapping probability based on a swap rule using the estimated probabilities from the probability estimator and the second probability estimator; and deciding whether to swap the samples based on the swapping probability.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A combinatorial optimization accelerator, comprising:
a memory management system on a parallel processor, the memory management system coupled to a memory of the parallel processor, wherein the memory stores a weight matrix;
a sampling engine on the parallel processor, the sampling engine coupled to receive weights of the weight matrix stored in the memory from the memory management system and perform as a restricted Boltzmann machine for a set of inputs using the received weights, wherein the sampling engine comprises a dual architecture of a first circuit for updating visible states and a second circuit for updating hidden states; and
a probability estimator that receives updated visible states and updated hidden states from the sampling engine.

2. The combinatorial optimization accelerator of claim 1, wherein the first circuit comprises circuitry of a first plurality of two-input AND gates, each AND gate receiving a first corresponding input and weight, and a first adder tree receiving outputs of the first plurality of two-input AND gates; and
wherein the second circuit comprises circuitry of a second plurality of two-input AND gates, wherein each AND gate receives a second corresponding input and weight and is coupled to output to a corresponding accumulator.

3. The combinatorial optimization accelerator of claim 2, wherein the first circuit further comprises a first multiplier that multiplies an output of the first adder tree with a temperature parameter;
wherein the second circuit further comprises a second multiplier coupled to each corresponding accumulator to multiply an output of that corresponding accumulator with the temperature parameter.

4. The combinatorial optimization accelerator of claim 1, wherein the first circuit comprises circuitry of a first plurality of two-input AND gates, and a first adder tree receiving outputs of the first plurality of two-input AND gates; and
wherein the second circuit comprises circuitry of a second plurality of two-input AND gates, and a second adder tree receiving outputs of the second plurality of two-input AND gates.

5. The combinatorial optimization accelerator of claim 4, wherein the first circuit further comprises a first multiplier that multiplies an output of the first adder tree with a temperature parameter;
wherein the second circuit further comprises a second multiplier that multiplies an output of the second adder tree with the temperature parameter.

6. The combinatorial optimization accelerator of claim 1, wherein the sampling engine comprises a set of at least three circuit blocks and selection logic, wherein the selection logic selects one of the set of at least three circuit blocks as the first circuit and another of the set of at least three circuit blocks as the second circuit.

7. The combinatorial optimization accelerator of claim 6, wherein the set of at least three circuit blocks comprises a first circuit block and a second circuit block;
wherein the first circuit block comprises circuitry of a first plurality of two-input AND gates, each AND gate receiving a first corresponding input and weight, and a first adder tree receiving outputs of the first plurality of two-input AND gates; and
wherein the second circuit block comprises circuitry of a second plurality of two-input AND gates, each AND gate receiving a second corresponding input and weight and coupled to output to a corresponding accumulator.

8. The combinatorial optimization accelerator of claim 7, wherein the set of at least three circuit blocks further comprises a third circuit block having a same configuration of circuitry as the circuitry of the first circuit block.

9. The combinatorial optimization accelerator of claim 7, wherein the set of at least three circuit blocks further comprises a fourth circuit block having a same configuration of circuitry as the circuitry of the second circuit block.

10. The combinatorial optimization accelerator of claim 6, wherein the first circuit and the second circuit have a same configuration.

11. The combinatorial optimization accelerator of claim 6, wherein the first circuit and the second circuit have different configurations.

12. The combinatorial optimization accelerator of claim 1, further comprising:
a second sampling engine on the parallel processor, the second sampling engine coupled to receive the weights of the weight matrix stored in the memory from the memory management system and perform as the restricted Boltzmann machine for the set of inputs using the received weights, wherein the second sampling engine comprises the dual architecture of the first circuit for updating visible states and the second circuit for updating hidden states;
a second probability estimator that receives updated visible states and updated hidden states from the sampling engine; and
a swap controller coupled to receive outputs of the probability estimator and the second probability estimator and perform sample swaps between the sampling engine and the second sampling engine based on the received outputs of the probability estimator and the second probability estimator.

13. The combinatorial optimization accelerator of claim 12, wherein the sampling engine and the second sampling engine each receive a corresponding temperature parameter multiplier.

14. The combinatorial optimization accelerator of claim 1, wherein the memory management system streams rows of the weights stored in the memory to the sampling engine.

15. The combinatorial optimization accelerator of claim 1, wherein the memory management system streams columns of the weights stored in the memory to the sampling engine.

16. The combinatorial optimization accelerator of claim 1, wherein the memory management system streams diagonals of the weights stored in the memory to the sampling engine.

17. A method of operating a combinatorial optimization accelerator comprising: a memory management system on a parallel processor, the memory management system coupled to a memory of the parallel processor, wherein the memory stores a weight matrix; a sampling engine on the parallel processor, the sampling engine coupled to receive weights of the weight matrix stored in the memory from the memory management system and perform as a restricted Boltzmann machine for a set of inputs using the received weights, wherein the sampling engine comprises a dual architecture of a first circuit for updating visible states and a second circuit for updating hidden states; and a probability estimator that receives updated visible states and updated hidden states from the sampling engine, the method comprising:
receiving, at the combinatorial optimization accelerator, a problem to be solved from a host system;
streaming, by the memory management system, the weights to the sampling engine;
receiving, by the sampling engine, a set of inputs and the weights from the memory management system to perform parallel updates of the visible states and the hidden states;
receiving, by the probability estimator, the updated visible states and the updated hidden states from the sampling engine to identify states that satisfy certain criteria; and
outputting, by the probability estimator, the identified states for the host system to indicate problem completion.

18. The method of claim 17, wherein the combinatorial optimization accelerator further comprises a swap controller and at least a second sampling engine and a second probability estimator, the method further comprising:
streaming, by the memory management system, the weights to the second sampling engine;
receiving, by the second sampling engine, the set of inputs and the weights from the memory management system to perform parallel updates of corresponding visible states and corresponding hidden states;
receiving, by the second probability estimator, the updated corresponding visible states and the updated corresponding hidden states from the second sampling engine to identify states that satisfy certain criteria;
receiving, at the swap controller, estimated probabilities from the probability estimator and the second probability estimator; and
performing, by the swap controller, swaps of samples for visible states and hidden states between the sampling engine and the second sampling engine based on the estimated probabilities from the probability estimator and the second probability estimator.

19. The method of claim 18, further comprising:
receiving, by the sampling engine and the second sampling engine, corresponding temperature parameters; and
multiplying, at the sampling engine and the second sampling engine, the corresponding temperature parameters with visible updates and hidden updates at that sampling engine.

20. The method of claim 18, wherein performing, by the swap controller, swaps of samples for visible states and hidden states between the sampling engine and the second sampling engine based on the estimated probabilities from the probability estimator and the second probability estimator comprises:
calculating a swapping probability based on a swap rule using the estimated probabilities from the probability estimator and the second probability estimator; and
deciding whether to swap the samples based on the swapping probability.
